(19) United States
(12) Patent Application Publication
(10) Pub. No.: US 2009/0002284 A1
(43) Pub. Date: Jan. 1, 2009

(54) Image Display Apparatus

(75) Inventor: Atsushi Katagiri, Kanagawa (JP)

Correspondence Address: PEARNE & GORDON LLP, 1801 EAST 9TH STREET, SUITE 1200, CLEVELAND, OH, 44114-3108, US

(73) Assignee: MATSUSHITA ELECTRIC INDUSTRIAL CO., LTD., Osaka (JP)

(21) Appl. No.: 12/279,662

(22) PCT Filed: Oct. 31, 2006
(86) PCT No.: PCT/JP2006/321777

§ 371 Date: Aug. 15, 2008

(51) Int. Cl. G09G 3/30

(52) U.S. Cl. 345/76

(57) ABSTRACT

It is an object of the invention to provide an image display apparatus in which noticeability of image persistence of a self-luminous device can be suppressed to a low level without performing an electric control and by a simple configuration.

In correspondence with a fixed image area (11a) of a self-luminous device (11), an opacified fixed image area (16) is formed in a transmission panel (15), and a fixed picture which is a fixed image that is susceptible to image persistence is placed in the fixed image area (16). According to the configuration, edges of the fixed picture are blurred, and noticeability of image persistence of the self-luminous device (11) is reduced. Therefore, noticeability of image persistence of the self-luminous device (11) can be suppressed to a low level without performing an electric control and by a simple configuration. A fixed picture originally has high contrast. Even when its edges are slightly blurred, therefore, its visibility is not largely impaired.

### TECHNICAL FIELD

The present invention relates to an image display apparatus comprising a self-luminous device such as an organic EL (electroluminescence) device.

### BACKGROUND ART

An organic EL device self-luminously emits light, and hence has an advantage that a backlight, which is necessary in a liquid crystal display apparatus, is not necessary and an apparatus can be further thinned and lightened. On the other hand, in an organic EL device, when the organic EL device emits light for a fixed time period or longer, however, the brightness is lowered to less than a predetermined brightness, or the life expires. Therefore, there is a disadvantage that image persistence occurs in which, when a specific image continues to be displayed, aging deterioration proceeds only in an element corresponding to the image, and the brightness is lowered only in the corresponding element. A major cause of a noticeable appearance of image persistence is a display of a fixed picture which is a fixed image (in the case of a portable terminal, for example, an antenna symbol or a battery symbol). It is expected that an organic luminescent material which produces less image persistence due to luminescence, and which has a long life is developed. However, the present situation is that the development is restricted to a material in which noticeable appearance of image persistence is suppressed to a low level as far as possible. Several methods of realizing this have been proposed (for example, see Patent Reference 1). Patent Reference 1 discloses the following three methods.

When an image is displayed, an area where the image is not displayed is displayed by a color of about 30% white which is estimated as the average brightness of a usual image.

When a character is displayed, a black character display mode where the character portion is displayed by black or a color which is lower in brightness than a background portion, and the background portion is displayed by white or a color which is higher in brightness than the character portion, and a white character display mode where the background portion is displayed by black or a color which is lower in brightness than the character portion, and the character portion is displayed by white or a color which is higher in brightness than the background portion are disposed. The display modes are switched over at a predetermined period, a predetermined timing which corresponds to a user operation, or a random timing.

In a display of a fixed image (fixed picture) in which lighting portions are increased or decreased depending on the situation, the display brightness is previously set to be lower in a portion where the probability of lighting is higher.

Patent Reference 1: WO2003/075255 (Japanese Patent Application No. 2003-573631)

### DISCLOSURE OF THE INVENTION

### Problems that the Invention is to Solve

However, all of the above-described methods of suppressing a noticeability of image persistence in a conventional organic EL device to a low level are performed based on an electrical control, and require a dedicated circuit and programs for enabling the circuit to operate, thereby producing a problem in that the cost of a products is correspondingly high.

The invention has been conducted in view of these circumstances. It is an object of the invention to provide an image display apparatus in which the noticeability of image persistence of a self-luminous device can be suppressed to a low level without performing an electric control and by a simple configuration.

### Means for Solving the Problems

The object is accomplished by the following configuration.

The image display apparatus of the invention comprises: a self-luminous device which is formed into a flat plate-like shape, and which has a fixed image area for displaying a fixed image that is to light for a predetermined time period or longer; and a transmission panel which is placed in close proximity to a side of a display surface of the self-luminous device, and an opacified area is disposed in the self-luminous device or the transmission panel in correspondence with the fixed image area.

According to the configuration, a fixed image which is susceptible to image persistence is placed in the opacified area, whereby edges of the fixed image are blurred and noticeability of image persistence of the self-luminous device is reduced. In this way, noticeability of image persistence of the self-luminous device can be suppressed to a low level without performing an electric control and by a simple configuration. A fixed image originally has high contrast. Even when its edges are slightly blurred, therefore, its visibility is not largely impaired.

In the image display apparatus of the invention, gradation is provided at least in the opacified fixed image area, and a fixed image having a high lighting probability is placed in a lower transmittance side of the fixed image area.

According to the configuration, in the case where there are plural fixed images having different lighting probabilities, a fixed image having a higher lighting probability is placed in a side of a lower transmittance area, whereby noticeability of image persistence of the whole fixed images with respect to the self-luminous device can be uniformized.

In the image display apparatus of the invention, the fixed image is configured by at least two portions having different lighting probabilities, a portion having a higher lighting probability is placed in a lower transmittance side of the fixed image area, and a portion having a lower lighting probability is placed in a higher transmittance side of the fixed image area.

According to the configuration, in the case where there is a fixed image configured by plural portions having different lighting probabilities, such as an antenna symbol and a battery symbol of a portable terminal, a portion having a higher lighting probability is placed in a lower transmittance side, and a portion having a lower lighting probability is placed in a higher transmittance side, whereby noticeability of image persistence of the fixed image configured by plural portions having different lighting probabilities with respect to the self-luminous device can be uniformized.

In the image display apparatus of the invention, gradation is provided in the fixed image area in a vertical direction which coincides with a width direction of the fixed image area.

According to the configuration, in the case where plural fixed images having different lighting probabilities are displayed in the vertical direction, a fixed image having a higher lighting probability is placed in a side of a lower transmittance area, and a fixed image having a lower lighting probability is placed in a higher transmittance side, whereby noticeability of image persistence of the whole fixed images with respect to the self-luminous device can be uniformized.

In the image display apparatus of the invention, gradation is provided in the fixed image area in a horizontal direction which coincides with a length direction of the fixed image area.

According to the configuration, in the case where plural fixed images having different lighting probabilities are displayed in the horizontal direction a fixed image having a higher lighting probability is placed in a side of a lower transmittance area, and a fixed image having a lower lighting probability is placed in a higher transmittance side, whereby noticeability of image persistence of the whole fixed images with respect to the self-luminous device can be uniformized.

In the image display apparatus of the invention, gradation is provided in the fixed image area in each of a vertical direction which coincides with a width direction of the fixed image area, and a horizontal direction which coincides with a length direction of the fixed image area.

According to the configuration, the transmittance can be changed not in a manner that it is linearly continuously changed, but in a manner that it is partially (or stepwise) changed. In the case where a fixed image is configured by plural portions having different lighting probabilities, as in an antenna symbol or a battery symbol of a portable terminal, the portions are sequentially arranged with starting from a portion having a highest lighting probability in the direction from a lower transmittance area to a higher transmittance area, whereby noticeability of image persistence of the whole antenna symbol with respect to the self-luminous device can be uniformized.

The portable terminal of the invention comprises any one of the above-described image display apparatuses.

According to the configuration, a fixed image which is susceptible to image persistence is placed in the opacified area, whereby edges of the fixed image are blurred and noticeability of image persistence of the self-luminous device is reduced.

The image display apparatus of the invention comprises: a self-luminous device which is formed into a flat plate-like shape, and which has a first area for displaying a fixed image that is to light for a predetermined time period or longer, and a second area for displaying an irregular image having no regularity; a transmission panel which is placed in close proximity to a side of a display surface of the self-luminous device; an opacified area which is opacified in correspondence with the first area, and which is on the self-luminous device or the transmission panel; and a tranparentized area which is tranparentized in correspondence with the second area, which is higher in transmittance than the opacified area, and which is on the self-luminous device or the transmission panel.

According to the configuration, a fixed image which is susceptible to image persistence is placed in the opacified area, whereby edges of the fixed image are blurred and noticeability of image persistence of the self-luminous device is reduced. In this way, noticeability of image persistence of the self-luminous device can be suppressed to a low level without performing an electric control and by a simple configuration. A fixed image originally has high contrast. Even when its edges are slightly blurred, therefore, its visibility is not largely impaired.

### EFFECTS OF THE INVENTION

In the image display apparatus of the invention, noticeability of image persistence of a self-luminous device can be suppressed to a low level without performing an electric control and by a simple configuration.

### BRIEF DESCRIPTION OF THE DRAWINGS

FIG. 1 is an exploded perspective view schematically showing the configuration of an image display apparatus of Embodiment 1 of the invention.

FIG. 2 is a view graphically showing a transmission panel and its transmittance in the image display apparatus of Embodiment 1 of the invention.

FIG. 3 is a view graphically showing a transmission panel and its transmittance in an image display apparatus of Embodiment 2 of the invention.

FIG. 4 is a view graphically showing a transmission panel and its transmittance in an image display apparatus of Embodiment 3 of the invention.

FIG. 5 is a view enlargedly showing a left end portion of gradation which is provided in a fixed image area of the transmission panel of the image: display apparatus of Embodiment 3 of the invention, and graphically showing the transmittance of the portion.

FIG. 6 is a view showing an antenna symbol which is an example of a fixed image which is placed in a fixed image area of the transmission panel of the image display apparatus of Embodiment 3 of the invention.

FIG. 7 is a view showing a state where the antenna symbol is placed in the fixed image area of the transmission panel of the image display apparatus of Embodiment 3 of the invention.

### DESCRIPTION OF REFERENCE NUMERALS AND SIGNS

10 case
11 self-luminous device
11a fixed image area
12 cushion
13 upper panel
15, 20, 30 transmission panel
16, 21, 31 fixed image area
17 frame
20a, 30a, 30b outer peripheral end
40 antenna symbol

### BEST MODE FOR CARRYING OUT THE INVENTION

Hereinafter, preferred embodiments for carrying out the invention will be described in detail with reference to the drawings.

### Embodiment 1

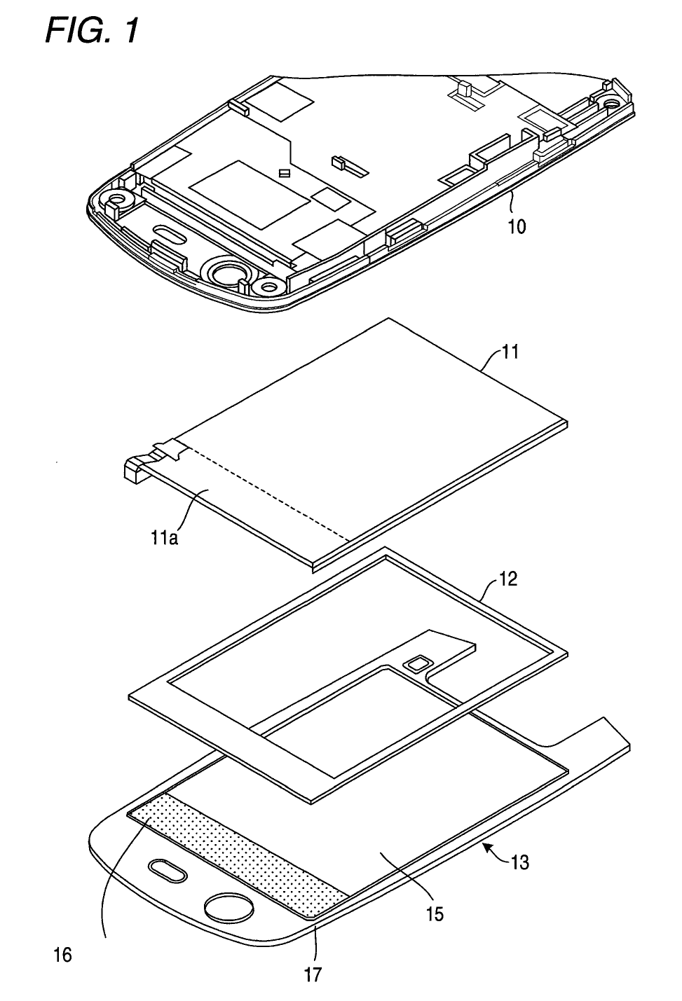

FIG. 1 is an exploded perspective view schematically showing the configuration of an image display apparatus of Embodiment 1 of the invention. The image display apparatus of the embodiment is applied to a portable terminal such as a portable telephone, and comprises: a self-luminous device 11 which is disposed in an upper portion of a case 10 of the portable terminal, which is formed into a flat plate-like shape, and which has a fixed image area 11a for displaying a fixed image that is to light for a predetermined time period or longer; and an upper panel 13 which is placed in close proximity to a side of a display surface of the self-luminous device 11. For example, an organic EL device is used as the self-luminous device 11. A cushion 12 which is formed into a rectangular frame-like shape by a buffer material such as urethane foam is interposed between the self-luminous device 11 and the upper panel 13.

The upper panel 13 is configured by a transmission panel 15, and a frame 17 which supports the transmission panel 15. In a part of the transmission panel 15, a strip-like fixed image area 16 which is opacified (this is equivalent to a lowering of the transmittance) is formed in the width direction (i.e., the horizontal direction) of the transmission panel 15 in correspondence with the fixed image area 11a of the self-luminous device 11. The opacified fixed image area 16 is used for lowering the absolute brightness. A fixed picture which is a fixed image to be displayed by the self-luminous device 11 is placed in the fixed image area 16, whereby edges of the fixed picture are blurred and noticeability of image persistence of the self-luminous device 11 is suppressed to a low level. Namely, the absolute brightness can be reduced by disposing the opacified fixed image area 16. When image persistence of the fixed picture occurs in the self-luminous device 11, therefore, the brightness difference between the portion where the image persistence occurs, and that where the image persistence does not occur is reduced, and hence noticeability of the image persistence can be suppressed to a low level. A fixed image used in a portable terminal; such as an antenna symbol or a battery symbol originally has very high contrast. Even when its edges are blurred and the brightness is lowered, therefore, its visibility is not largely impaired. Examples of opacifying the fixed image area 16 are a method in which the panel surface is roughened by filing, and that in which printing is performed on the panel surface.

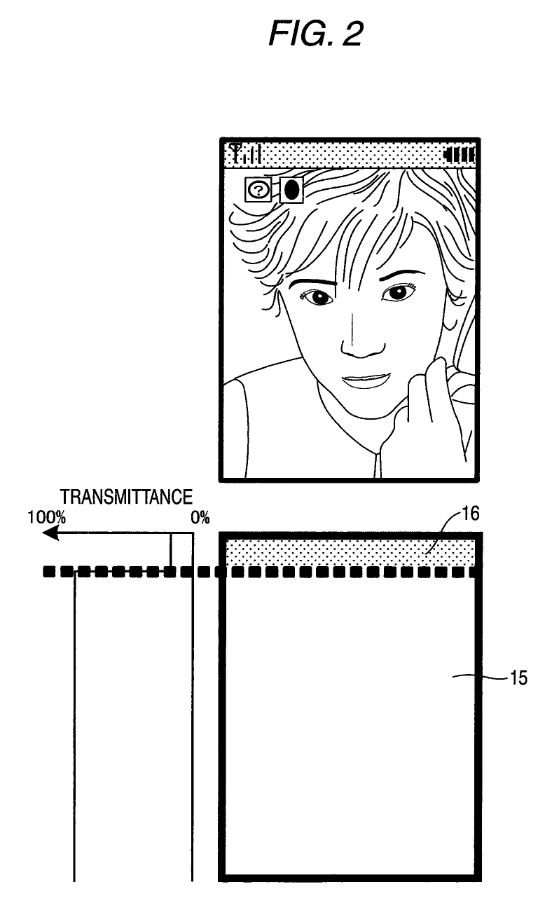

FIG. 2 is a view graphically showing the transmission panel 15 and its transmittance. As shown in the figure, the transmittance of the fixed image area 16 of the transmission panel 15 is uniform over the entire area, and, for example, about 20%, and that of the other portion (normal display area) is uniform over the entire portion, and ideally 100%. A normal image, i.e., an irregular image having no regularity is displayed in the normal display area.

The organic EL device has the following specification: for example, white brightness=150 cd/m²; black brightness=0.15 cd/m²; and contrast=1,000:1. When the transmission panel 15 is modeled so that the transmittance of a transparent portion (the normal display area other than the fixed image area 16 in the transmission panel 15)=100%, the transmittance of an opacified portion (the fixed image area 16 in the transmission panel 15)=50%, white brightness=200 cd/m², persistent white brightness=100 cd/m², and black brightness=1 cd/m², the difference between the white brightness of the transparent portion and the persistent white brightness is 100 cd/m², and that between the white brightness of the opacified portion and the persistent white brightness is 50 cd/m². The contrast is 200/1 (transparent portion)=100/0.5 (opacified portion)=200. This expression means that the contrast remains unchanged irrespective of the transparent portion or the opacified portion.

In the image display apparatus of the embodiment, as described above, the opacified fixed image area 16 is formed in the transmission panel 15, and the fixed picture which is a fixed image that is susceptible to image persistence is placed in the fixed image area 16. Therefore, noticeability of image persistence due to display of the fixed picture in the self-luminous device 11 can be suppressed to a low level. Namely, noticeability of image persistence of the self-luminous device 11 can be suppressed to a low level without performing an electric control and by a simple configuration.

In the embodiment, the fixed image area 16 is opacified by filing or performing printing on the transmission panel 15. Alternatively, a sticker-like film such as a smoke film (so-called car film) which is to be applied to a window of a vehicle may be applied to the surface of the transmission panel 15 or that of the self-luminous device 11, so that the applied portion functions as the opacified fixed image area 16.

### Embodiment 2

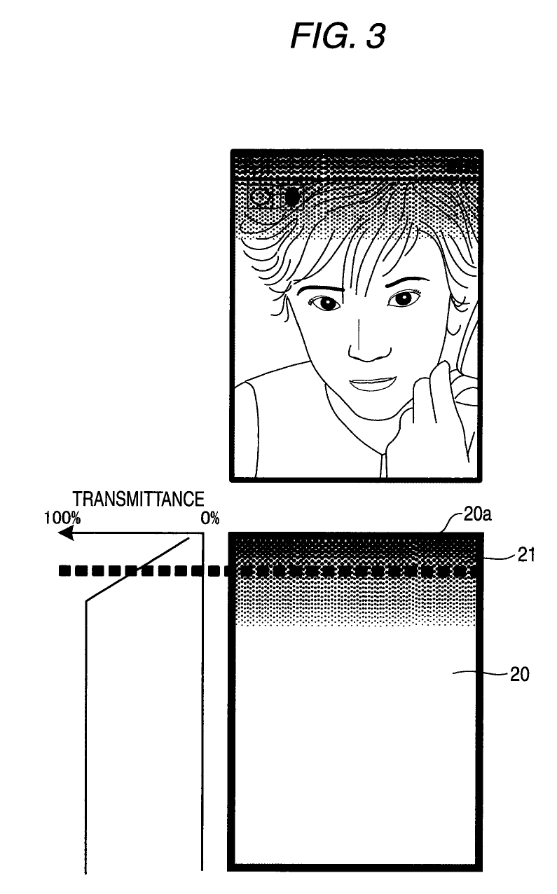

FIG. 3 is a view graphically showing a transmission panel and its transmittance in an image display apparatus of Embodiment 2 of the invention. In the figure, the transmission panel 20 of the image display apparatus in the embodiment is configured so that, in the same manner as the transmission panel 15 of Embodiment 1 described above, an opacified fixed image area 21 is formed in the transmission panel 20, but different from the transmission panel 15 in Embodiment 1 in that gradation is provided. In the gradation in the transmission panel 20, as apparent from the graphical display of FIG. 3 indicating the transmittance, the transmittance is increased gradually linearly in the width direction (i.e., the vertical direction) of the fixed image area 21. That is, the gradation of the transmission panel 20 in the embodiment is provided in such a manner that the transmittance is more increased as further advancing from an outer peripheral end 20a in the length direction of the transmission panel 20 toward the normal display area (i.e., the inner side) other than the fixed image area 21.

In the case where fixed pictures which are plural fixed images having different lighting probabilities are displayed in the gradationed area of the transmission panel 20 by the self-luminous device 11, a fixed picture having a lower lighting probability is placed in a higher transmittance side, and that having a higher lighting probability is placed in a lower transmittance side. In the case of a fixed picture having a high lighting probability, such as an antenna symbol or a battery symbol used in a portable terminal, for example, the fixed picture is placed in a lower transmittance side of the fixed image area 21. In this way, as image persistence occurs more easily, a fixed picture is placed in a lower transmittance side, whereby noticeability of image persistence of the whole fixed picture with respect to the self-luminous device 11 can be uniformized.

As described above, in the image display apparatus of the embodiment, the transmission panel 20 is provided with gradation so that the transmittance is more increased as further advancing from the outer peripheral end 20a in the length direction toward the normal display area (inner side) other than the fixed image area 21. In the case where there are fixed pictures which are plural fixed images having different lighting probabilities, as the lighting probability of each of the fixed pictures is higher, therefore, the fixed picture is placed in a lower transmittance side, whereby noticeability of image persistence of the whole fixed pictures with respect to the self-luminous device 11 can be uniformized.

In the embodiment, the transmission panel 20 is provided so that the transmittance is increased gradually linearly in the width direction (i.e., the vertical direction) of the fixed image area 21. Alternatively, gradation may be provided so that the transmittance is increased gradually linearly in the length direction (i.e., the horizontal direction) of the fixed image area 21. Also in the alternative, a fixed picture having a lower lighting probability is placed in a higher transmittance side, and a fixed picture having a higher lighting probability is placed in a lower transmittance side, whereby noticeability of image persistence of whole fixed pictures with respect to the self-luminous device 11 can be uniformized.

Also in the embodiment, in a similar manner as Embodiment 1, gradation is provided by filing or performing printing on the transmission panel 20.

Alternatively, gradation may be provided by applying a sticker-like film such as a smoke film (so-called car film) which is to be applied to a window of a vehicle, to the surface of the transmission panel 20 or that of the self-luminous device 11.

### Embodiment 3

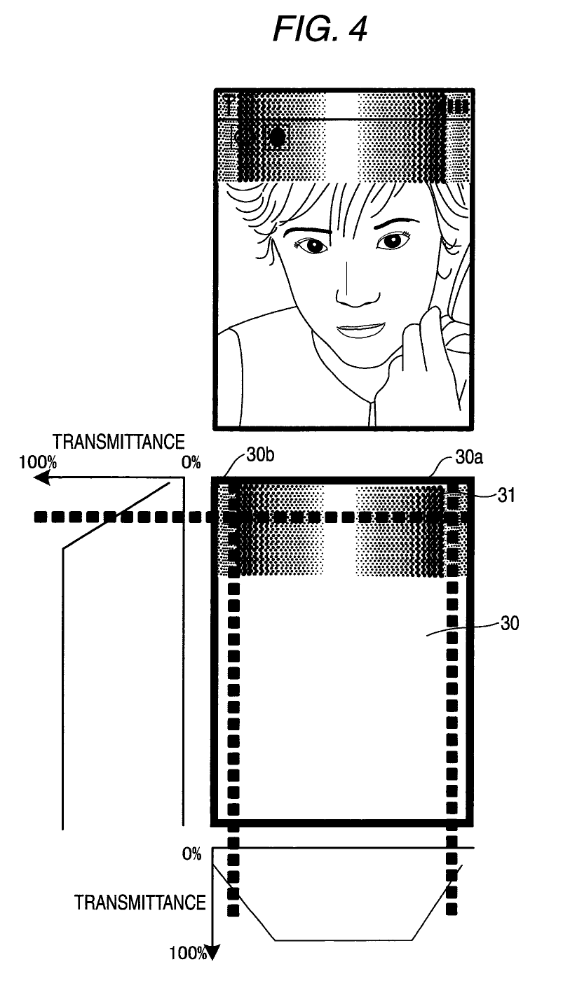

FIG. 4 is a view graphically showing a transmission panel and its transmittance in an image display apparatus of Embodiment 3 of the invention. In the figure, the transmission panel 30 of the image display apparatus of the embodiment is configured so that, in the same manner as the transmission panel 20 of Embodiment 2 described above, a gradationed fixed image area 31 is formed in the transmission panel 30, but different from the transmission panel 20 in Embodiment 2 in that gradation is provided in both the vertical and horizontal directions. In the gradation provided in the transmission panel 30 in the embodiment, particularly, as apparent from the graphical display of FIG. 4 indicating the transmittance, the transmittance is increased gradually linearly in the width direction (i.e., the vertical direction) of the fixed image area 31, and the transmittance is increased gradually linearly as advancing from each of both end portions in the length direction (i.e., the horizontal direction) toward the middle of the transmission panel 30.

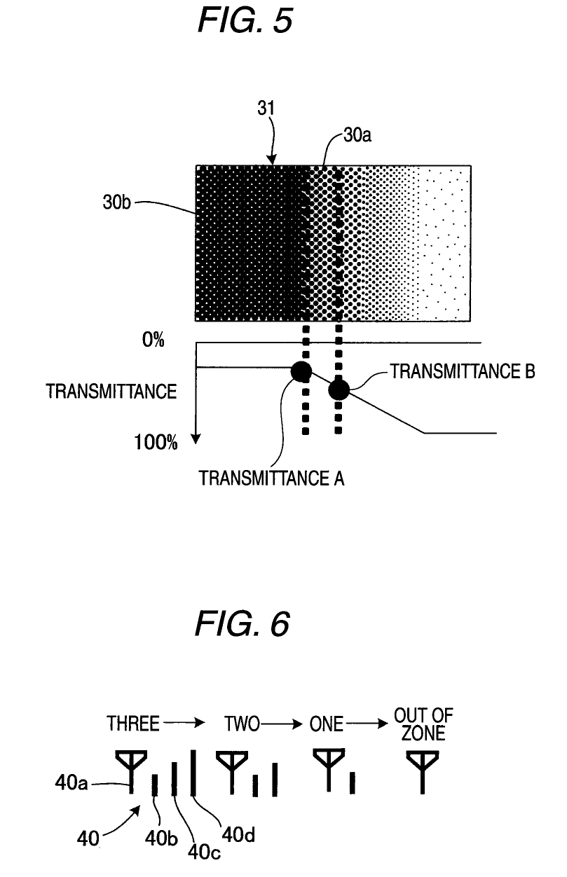

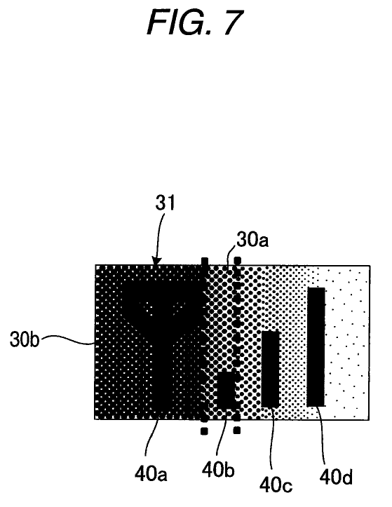

FIG. 5 is a view enlargedly showing a left end portion of the gradation which is provided in the fixed image area 31, and graphically showing the transmittance of the portion. As shown in the figure, in the direction from an outer peripheral end 30b in the width direction (i.e., the horizontal direction) of the transmission panel 30 toward the middle of the panel, the transmittance of the fixed image area 31 first has a constant value, and thereafter is increased gradually linearly until it reaches about 100% (transmittance A<transmittance B). In the case where, as in an antenna symbol 40 shown in FIG. 6, a fixed picture which is configured by plural portions 40a to 40d having different lighting probabilities is placed in the fixed image area 31, as shown in FIG. 7, the portion 40a having the highest lighting possibility is placed on the side of the outer peripheral end 30b where the transmittance is lowest, and the remaining portions 40b to 40d are sequentially arranged in the direction along which the transmittance becomes higher.

According to this placement, noticeability of image persistence of the self-luminous device 11 due to the portions 40a to 40d of the antenna symbol 40 can be uniformized. The lighting probabilities of the portions 40a to 40d of the antenna symbol 40 are 40a>40b>40c>40d. As a fixed picture which is configured by plural portions having different lighting probabilities, there is also a battery symbol in addition to the antenna symbol. Also in this case, the portions are placed in the same manner as the case of the antenna symbol, whereby noticeability of image persistence of the self-luminous device 11 due to the portions can be uniformized.

As described above, in the image display apparatus of the embodiment, the transmission panel 30 is provided with gradation in which the transmittance is increased gradually linearly as advancing from an outer peripheral end 30a in the length direction toward the normal display area (inside) other than the fixed image area 31, and increased gradually linearly as advancing from the outer peripheral end 30b of each of both end portions in the width direction toward the middle of the transmission panel 30. In the case where a fixed picture which is a fixed image configured by plural portions having different lighting probabilities is displayed, therefore, a portion having a lower lighting probability is placed in a higher transmittance side, and that having a higher lighting probability is placed in a lower transmittance side, whereby noticeability of image persistence of the self-luminous device 11 due to the fixed picture configured by plural portions having different lighting probabilities can be uniformized.

Also in the embodiment, in a similar manner as Embodiment 1, gradation is provided by filing or performing printing on the transmission panel 30. Alternatively, gradation may be provided by applying a sticker-like film such as a smoke film (so-called car film) which is to be applied to a window of a vehicle, to the surface of the transmission panel 30 or that of the self-luminous device 11.

In Embodiments 1 to 3 described above, the case where the invention is applied to a portable terminal is considered. However, the invention can be applied to all image display apparatuses having a function of displaying a fixed image such as a fixed picture.

In Embodiments 1 to 3 described above, the display of a normal image and that of a fixed picture are performed by the same self-luminous device 11, and hence the software control and the hardware configuration can be simplified as compared with the case where the display of a normal image and that of a fixed picture are separately performed. In the case where kinds of fixed pictures are small in number, conventionally, LEDs (light emitting diodes) for the fixed pictures light up. In the case where a fixed picture is displayed directly on the self-luminous device 11, even when the placement is physically changed from a vertical direction to the lateral direction or in a reverse manner, the display of a normal image and that of a fixed picture can freely correspond to each other.

In Embodiments 1 to 3 described above, an organic EL device is assumed as the self-luminous device 11. Alternatively, another device such as a plasma display device may be used.

While the invention has been described in detail with reference to specific embodiments, it will be obvious to those skilled in the art that various changes or modifications may be made without departing from the sprit and scope of the invention.

### INDUSTRIAL APPLICABILITY

The invention has an effect that noticeability of image persistence of a self-luminous device can be suppressed to a low level without performing an electric control and by a simple configuration, and can be applied to all image display apparatuses having a function of displaying a fixed image such as a fixed picture.

1-8. (canceled)

9. An image display apparatus, comprising:
a self-luminous device, formed into a flat plate-like shape, and having a fixed image area for displaying a fixed image that is to light for a predetermined time period or longer; and
a transmission panel, placed in close proximity to a side of a display surface of the self-luminous device,
wherein an opacified area is disposed in the self-luminous device or the transmission panel in correspondence with the fixed image area.

10. The image display apparatus according to claim 9, wherein gradation is provided at least in the opacified fixed image area, and a fixed image having a high lighting probability is placed in a lower transmittance side of the fixed image area.

11. The image display apparatus according to claim 10, wherein the fixed image is configured by at least two portions having different lighting probabilities, a portion having a higher lighting probability is placed in a lower transmittance side of the fixed image area, and a portion having a lower lighting probability is placed in a higher transmittance side of the fixed image area.

12. The image display apparatus according to claim 10, wherein gradation is provided in the fixed image area in a vertical direction which coincides with a width direction of the fixed image area.

13. The image display apparatus according to claim 10, wherein gradation is provided in the fixed image area in a horizontal direction which coincides with a length direction of the fixed image area.

14. The image display apparatus according to claim 10, wherein gradation is provided in the fixed image area in each of a vertical direction which coincides with a width direction of the fixed image area, and a horizontal direction which coincides with a length direction of the fixed image area.

15. A portable terminal wherein the portable terminal comprises an image display apparatus according to claim 9.

16. An image display apparatus comprising:
a self-luminous device, formed into a flat plate-like shape, and having a first area for displaying a fixed image that is to light for a predetermined time period or longer, and a second area for displaying an irregular image having no regularity;
a transmission panel, placed in close proximity to a side of a display surface of the self-luminous device;
an opacified area, opacified in correspondence with the first area, and which is on the self-luminous device or the transmission panel; and
a tranparentized area, tranparentized in correspondence with the second area, which is higher in transmittance than the opacified area, and which is on the self-luminous device or the transmission panel.
